(19) United States
(12) Patent Application Publication
(10) Pub. No.: US 2024/0124212 A1
(43) Pub. Date: Apr. 18, 2024

(54) MULTI-FUNCTION BEVERAGE CONTAINER

(71) Applicant: Lemonpig Outdoors LLC, Indialantic, FL (US)

(72) Inventors: Jennifer Solms Nelson, Orlando, FL (US); Andrew Hartley Nelson, Orlando, FL (US)

(21) Appl. No.: 18/380,471

(22) Filed: Oct. 16, 2023

Related U.S. Application Data
(60) Provisional application No. 63/416,096, filed on Oct. 14, 2022.

(51) Int. Cl. B65D 81/38; A47G 19/22; B67B 7/16; B67B 7/40

(52) U.S. Cl. CPC B65D 81/3869; A47G 19/2261; B67B 7/16; B67B 7/403

(57) ABSTRACT

A reusable beverage container has an inner liner with a cavity that contains a fluid therein, an outer shell attached over an external surface of the inner liner, a base at the bottom of the beverage container, a rim that is formed by the inner liner to define an opening of the beverage container, and, formed in the base of the beverage container, one or more of a bottle opener and a can opener. A method of making a reusable beverage container includes steps of forming an inner liner comprising a cavity for containing a fluid therein, attaching an outer shell over an external surface of the inner liner, and forming one or more of a bottle opener and a can opener.

### CROSS-REFERENCE TO RELATED APPLICATIONS

This application claims priority to U.S. Provisional Patent Application Ser. No. 63/416,096, which was filed on Oct. 14, 2022, the content of which is incorporated by reference herein in the entirety. Since Oct. 14, 2023, was a Saturday, the 1-year statutory deadline for the filing of this nonprovisional patent application falls on the next business day, Oct. 16, 2023.

### BACKGROUND

Cups are ubiquitous items in modern life and are useful to allow a person to carry a beverage with them while moving around (e.g., walking), standing, sitting, etc. It is common for a person, especially at a social gathering, to transfer the liquid contents of another container or vessel (e.g., a can, a bottle, etc.) into a cup both for convenience, ease of waste collection, and safety (e.g., to avoid a glass bottle breaking, such as may happen if accidentally dropped).

In order to pour the contents of such containers into a cup, it is often necessary to first open the container. For example, a glass bottle will often have a metal top affixed (e.g., in a liquid-tight manner) over the mouth of the glass bottle, which must be first removed before the contents of the bottle can be poured out of the glass bottle and into the cup. It is thus necessary for many people to use a bottle opener to remove the metal top from the glass bottle before being able to pour the contents of the bottle into a cup. Somewhat similarly, a metal can will typically have a pull-tab that must be bent to form a hole in a top of the can before the contents of the can are able to be poured out of the can. It is common for some people to, whether due to an inability to manipulate the pull tab or due to a desire to not risk damage to his/her fingernails for such people to require the use of a tool to open a can.

It is further common at social events for beverages to be consumed, some of which were stored/transported in a metal can and some of which were storage/transported in a glass bottle, thus requiring a party host to provide a plurality of different tools for opening the different types of beverage containers. These tools are easily misplaced and the provision of multiples of such tools is undesirable. As such, a need exists at present for a sufficiently rigid beverage cup with features integrated therein (e.g., formed as a unitary structure, not as a separate and discrete part of the cup) for opening different types of beverage containers.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this summary does not list or suggest all possible combinations of such features.

The following presents a summary to provide a basic understanding of one or more embodiments of the disclosure. This summary is not intended to identify key or critical elements, or to delineate any scope of particular embodiments or any scope of the claims. Its sole purpose is to present concepts in a simplified form as a prelude to the more detailed description that is presented later.

In a first example embodiment, a reusable beverage container is provided herein, the beverage cup comprising an inner liner comprising a cavity that is configured to contain a fluid therein, an outer shell attached over an external surface of the inner liner, and one or more of a bottle opener and a can opener.

In some such embodiments of the beverage container, the outer shell comprises a base, which has a bottom surface that defines a bottom of the beverage container and the bottle opener is in a form of a recess that is formed in and extends away from the bottom surface of the outer shell, in a manner such that the recess is internal to the base of the outer shell, the recess being configured for engaging with a bottle cap for removing the bottle cap from a bottle.

In some such embodiments of the beverage container, the bottle cap comprises a plurality of vertically oriented ridges formed around an outer circumferential surface thereof; the recess is formed such that a plurality of vertically oriented ridges are formed around an inner circumferential surface thereof; the ridges are formed and spaced about the inner circumferential surface of the recess such that a corresponding one of the ridges of the bottle cap can be inserted therein; and when the beverage container and the bottle are twisted relative to each other along a longitudinal axis of the beverage container, the bottle opener is configured to twist the bottle cap off of the bottle. Optionally or in the alternative, the can opener comprises a slot that is formed in an outer circumferential surface of the base, the slot extending radially inwardly from the outer circumferential surface.

In some such embodiments of the beverage container, the slot is configured such that a pull tab of a can is insertable at least partially into the slot such that, by moving the can relative to the beverage container about a pivot point of the pull tab, the beverage container is configured to actuate the pull tab for opening the can; and/or the can opener comprises a hole or second slot configured for draining from the slot a fluid and/or debris contained within the slot during a cleaning process of the beverage container.

In some such embodiments, the beverage container comprises a plurality of beads within a base of the beverage container to resist the beverage container from tipping over.

In some such embodiments of the beverage container, the plurality of beads are embedded within the inner liner or contained within the base between the liner shell and the outer shell; the plurality of beads comprise a metal and/or a phase-change material and are positioned directly adjacent to the cavity of the inner liner and are configured to provide heat transfer with the fluid for heating or cooling the fluid to maintain a desired temperature of the fluid for a longer period of time than without the plurality of metallic beads; the plurality of beads form a textured surface within at least a portion of the cavity formed by the inner liner, the texture being configured to improve, relative to a flat surface, an efficiency of heat transfer between the plurality of beads and the fluid; and/or the plurality of beads are also adjacent to and vertically along a portion of an inner circumferential wall of the inner liner.

In some such embodiments, the beverage container comprises a hollow region formed between the inner liner and the outer shell, wherein the hollow region insulates the fluid.

In some such embodiments of the beverage container, the hollow region is vacuum sealed to be devoid of air, liquid, and/or solid within the hollow region.

In some such embodiments of the beverage container, the outer shell comprises, formed over a portion of an outer circumferential surface thereof, a plurality of protrusions for aiding manual gripping of the beverage container by a person.

In some such embodiments, the beverage container comprises a plurality of annular ridges about the outer circumferential surface of the outer shell for aiding a person in gripping the beverage container.

In some such embodiments of the beverage container, the portion of the outer circumferential surface of the outer shell, over which the plurality of protrusions are formed, is formed of a different material than a remaining portion of the outer circumferential surface of the outer shell.

In some such embodiments of the beverage container, the different material comprises silicone, rubber, plastic, and/or metal.

In some such embodiments, the beverage container comprises, at a top surface of the beverage container, an annular rim that defines an opening of the beverage container, the opening being formed such that fluid can be introduced into and extracted from the cavity through the opening.

In some such embodiments of the beverage container, the rim is a widest portion of the beverage container; and/or the rim comprises, formed therein, grooves that are configured to retain therein and/or thereon a garnish that is designated to accompany the fluid within the cavity of the inner liner of the beverage container.

In some such embodiments of the beverage container, the grooves are concentrically arranged about the rim with respect to each other.

In some such embodiments of the beverage container, the beverage container comprises a textured surface on a bottom surface of the outer shell, the textured surface being configured to provide insulation to the beverage container and to resist the beverage container from slipping when placed on a surface or when held in a hand of a person; and/or the cavity of the inner liner is configured to contain therein a maximum volume of the fluid of between about 6 fluid ounces and about 24 fluid ounces, inclusive; and/or the beverage container is in a form of a cup.

In some such embodiments, the beverage container comprises, formed in the base, a lever-style bottle opener configured to pry a bottle cap off a bottle by engagement of the bottle cap within a recess of the lever-style bottle opener and against a lever arm of the lever-style bottle opener to exert a removal force on the bottle cap.

In some such embodiments of the beverage container, the removal force is a moment exerted about an edge of the lever arm.

In a second example embodiment, a method of making a multi-function reusable beverage container is provided herein, the method comprising forming an inner liner comprising a cavity for containing a fluid therein; attaching an outer shell over an external surface of the inner liner; and forming one or more of a bottle opener and a can opener.

In some such embodiments of the method, the outer shell comprises a base, which has a bottom surface that defines a bottom of the beverage container; and the bottle opener is in a form of a recess that is formed in and extends away from the bottom surface of the outer shell, in a manner such that the recess is internal to the base of the outer shell and, optionally, the method comprises engaging a bottle cap attached to a bottle in the recess; and twisting the bottle relative to the beverage container to remove the bottle cap from the bottle.

In some such embodiments of the method, the bottle cap comprises a plurality of vertically oriented ridges formed around an outer circumferential surface thereof; the recess is formed such that a plurality of vertically oriented cavities are formed around an inner circumferential surface thereof; the cavities are formed and spaced about the inner circumferential surface of the recess such that a corresponding one of the ridges of the bottle cap can be inserted therein; and, when the beverage container and the bottle are twisted relative to each other along a longitudinal axis of the beverage container, the bottle opener twists the bottle cap off of the bottle. Optionally or in the alternative, the can opener comprises a slot that is formed in an outer circumferential surface of the base, the slot extending radially inwardly from the outer circumferential surface.

In some such embodiments of the method, the method comprises inserting a pull tab of a can at least partially into the slot such that, by moving the can relative to the beverage container about a pivot point of the pull tab, the beverage container actuates the pull tab for opening the can; and/or the can opener comprises a hole or second slot for draining from the slot a fluid and/or debris contained within the slot during a cleaning process of the beverage container.

The method of claim 23, comprising providing a plurality of beads within a base of the beverage container to resist the beverage container from tipping over.

In some such embodiments of the method, the plurality of beads are embedded within the inner liner or contained within the base between the liner shell and the outer shell; the plurality of beads comprise a metal and/or a phase-change material and are positioned directly adjacent to the cavity of the inner liner and are configured to provide heat transfer with the fluid for heating or cooling the fluid to maintain a desired temperature of the fluid for a longer period of time than without the plurality of metallic beads; the plurality of beads form a textured surface within at least a portion of the cavity formed by the inner liner, the texture being configured to improve, relative to a flat surface, an efficiency of heat transfer between the plurality of beads and the fluid; and/or the plurality of beads are also adjacent to and vertically along a portion of an inner circumferential wall of the inner liner.

In some such embodiments, the method comprises forming a hollow region between the inner liner and the outer shell that insulates the fluid.

In some such embodiments of the method, the hollow region is vacuum sealed so as to be devoid of air, liquid, and/or solid within the hollow region.

In some such embodiments, the method comprises forming, over a portion of an outer circumferential surface of the outer shell, a plurality of protrusions for aiding manual gripping of the beverage container by a person.

In some such embodiments of the method, the portion of the outer circumferential surface of the outer shell, over which the plurality of protrusions are formed, is formed of a different material than a remaining portion of the outer circumferential surface of the outer shell.

In some such embodiments of the method, the different material comprises silicone, rubber, plastic, and/or metal.

In some such embodiments, the method comprises forming, at a top surface of the beverage container, an annular rim that defines an opening of the beverage container, the opening being formed such that fluid can be introduced into and extracted from the cavity through the opening.

In some such embodiments of the method, the rim is a widest portion of the beverage container; and/or wherein the method comprises forming, in the rim, grooves configured to retain therein and/or thereon a garnish that is designated to accompany the fluid within the cavity of the inner liner of the beverage container.

In some such embodiments of the method, the grooves are concentrically arranged about the rim with respect to each other.

In some such embodiments, the method comprises a plurality of annular ridges about the outer circumferential surface of the outer shell for aiding a person in gripping the beverage container.

In some such embodiments of the method, the method comprises using a textured surface on a bottom surface of the outer shell to insulate the beverage container and to resist the beverage container from slipping when placed on a surface or when held in a hand of a person; and/or the cavity of the inner liner is shaped to contain therein a maximum volume of the fluid of between about 6 fluid ounces and about 24 fluid ounces, inclusive; and/or the beverage container is in a form of a cup.

In some such embodiments, the method comprises forming a lever-style bottle opener in the base, the lever-style bottle opener comprising a recess and a lever arm; engaging a bottle cap that is secured over a mouth of a bottle within the recess of the lever-style bottle opener; and prying the bottle cap off of the bottle by engaging the bottle cap against the lever arm of the lever-style bottle opener to exert a removal force on the bottle cap.

In some such embodiments of the method, the removal force is a moment exerted about an edge of the lever arm.

### BRIEF DESCRIPTION OF THE DRAWINGS

The presently disclosed subject matter can be better understood by referring to the following figures. The components in the figures are not necessarily to scale, emphasis instead being placed upon illustrating the principles of the presently disclosed subject matter (often schematically). In the figures, like reference numerals designate corresponding parts throughout the different views. A further understanding of the presently disclosed subject matter can be obtained by reference to an embodiment set forth in the illustrations of the accompanying drawings. Although the illustrated embodiment is merely an example of systems for carrying out the presently disclosed subject matter, both the organization and method of operation of the presently disclosed subject matter, in general, together with further objectives and advantages thereof, may be more easily understood by reference to the drawings and the following description. The drawings are not intended to limit the scope of this presently disclosed subject matter, which is set forth with particularity in the claims as appended or as subsequently amended, but merely to clarify and exemplify the presently disclosed subject matter.

FIG. 1 is a side view of an example embodiment of a reusable beverage container.

FIG. 2 is a perspective view of the reusable beverage container shown in FIG. 1.

FIG. 3 is a top view of the reusable beverage container shown in FIGS. 1 and 2.

FIG. 4 is a perspective view of the reusable beverage container shown in FIGS. 1-3.

FIG. 5 is a bottom view of the reusable beverage container shown in FIGS. 1-4.

FIG. 6 is a cross-sectional view of the reusable beverage container shown in FIGS. 1-5, the cross-sectional view being taken across cut-plane 6-6 in FIG. 1.

FIG. 7 is a perspective view of another example embodiment of a reusable beverage container.

FIG. 8 is a top view of the reusable beverage container shown in FIG. 7.

FIG. 9 is a perspective view of another example embodiment of a reusable beverage container.

FIG. 10 is a perspective view showing the bottom surface of the reusable beverage container shown in FIG. 9, the reusable beverage container is being used to engage with a bottle cap for unscrewing the bottle cap from a bottle to which such bottle cap is threadably attached.

FIG. 11 is a perspective view showing the bottom surface of the reusable beverage container shown in FIG. 9, the reusable beverage container having been used to remove the bottle cap from the bottle shown in FIG. 10 and the reusable beverage container having the bottle cap held within the recess formed in the bottom surface of the reusable beverage container.

FIG. 12 is a perspective view showing the can opener of the reusable beverage container shown in FIG. 9 being used to open a drink can with a pull tab.

FIG. 13 is a perspective view showing the pull tab of the drink can held within the can opener of the reusable beverage container shown in FIG. 9.

FIG. 14 is a bottom perspective view of the reusable beverage container shown in FIG. 9.

FIG. 15 is a side view of another example embodiment of a sleeve for use with the reusable beverage containers disclosed herein.

FIG. 16 is a perspective view of the example embodiment of the sleeve shown in FIG. 15.

FIG. 17 is a perspective view of another example embodiment of a reusable beverage container.

FIG. 18 is a bottom view of the reusable beverage container shown in FIG. 17.

### DETAILED DESCRIPTION

In the description below, without being restricted hereto, specific details are presented in order to give a complete understanding of the disclosure herein. It is, however, clear to a person skilled in the art that the disclosure herein may be used in other example embodiments which may differ from the details outlined below. The figures serve furthermore merely to illustrate example embodiments, are not to scale, and serve merely to illustrate by example the general concept of the disclosure herein. For example, features contained in the figures must not necessarily be considered to be essential components.

Comparable or identical components and features, or those with similar effect, carry the same reference signs in the figures. For reasons of clarity, in the figures sometimes the reference signs of individual features and components have been omitted, wherein these features and components carry reference signs in the other figures.

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the presently disclosed subject matter.

While the following terms are believed to be well understood by one of ordinary skill in the art, the following definitions are set forth to facilitate explanation of the presently disclosed subject matter.

All technical and scientific terms used herein, unless otherwise defined herein, are intended to have the same meaning as commonly understood by one of ordinary skill in the art. References to techniques employed herein are intended to refer to the techniques as commonly understood in the art, including variations on those techniques or substitutions of equivalent techniques that would also be apparent to one of skill in the art. While the following terms are believed to be well understood by one of ordinary skill in the art, the following definitions are set forth to facilitate explanation of the presently disclosed subject matter.

In describing the presently disclosed subject matter, it should be understood that a number of techniques, features, steps, etc. are disclosed. Each of these has individual benefit and each can also be used in conjunction with one or more, or in some cases all, of the other disclosed techniques, features, steps, etc.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a vertical post” includes a plurality of such vertical posts, and so forth.

Unless otherwise indicated, all numbers expressing quantities of structures, features, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, dose, mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate for the disclosed devices, compositions, systems and/or methods.

The term “comprising,” which is synonymous with “including,” “containing,” and/or “characterized by,” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or feature not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

As used herein, the term “and/or,” when used in the context of a listing of entities, refers to the entities being present singly or in any combination. Thus, for example, the phrase “A, B, C, and/or D” includes A, B, C, and D individually, but also includes any and all combinations and subcombinations of A, B, C, and D.

It will be understood that various details of the presently disclosed subject matter may be changed without departing from the scope of the presently disclosed subject matter. Furthermore, the foregoing description is for the purpose of illustration only, and not for the purpose of limitation.

As used herein, the terms “cup” and “beverage container” may be used interchangeably, but the subject matter recited herein is not to be limited in any way to embodiments that would be considered to comport generally with a conventionally-shaped cup and may include other containers or vessels that are intended for use in containing substances other than a liquid that is intended for consumption by a human being.

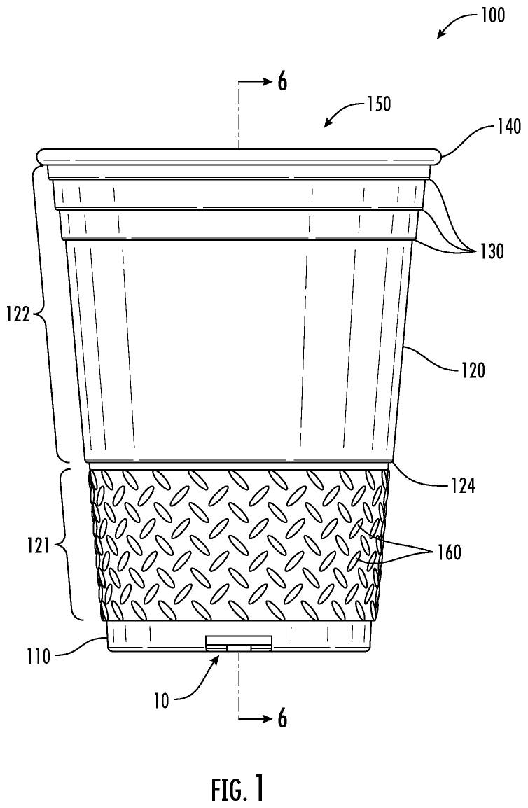

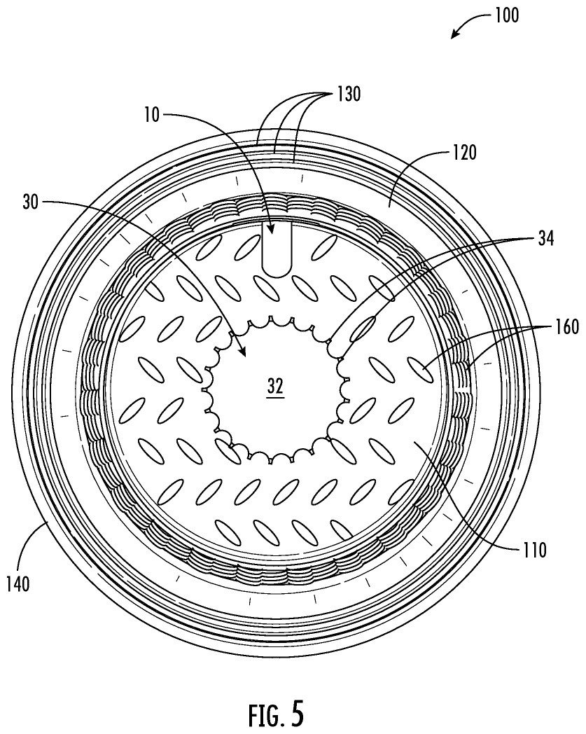

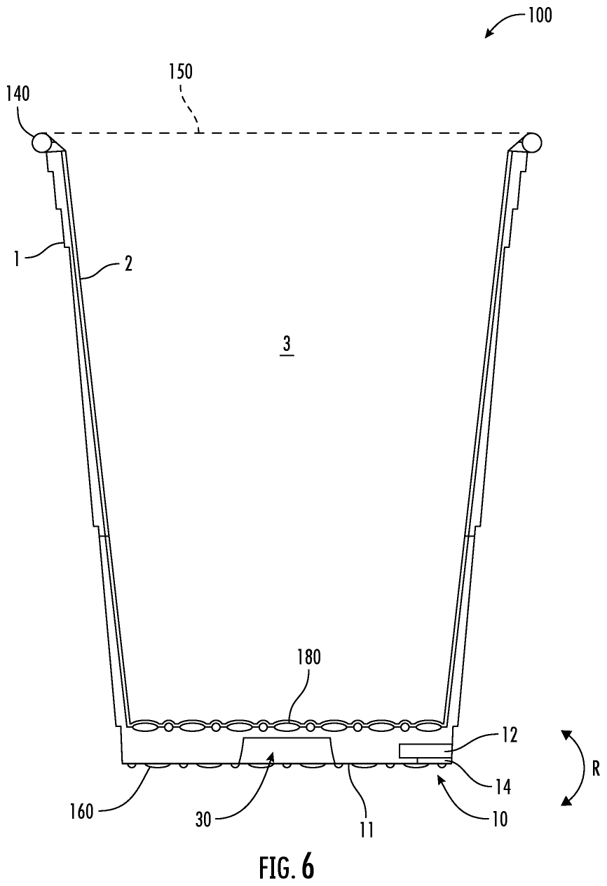

FIGS. 1-6 show various aspects of an example embodiment of a beverage container, or cup, generally designated 100. According to this example embodiment, the cup 100 comprises an inner liner 2 and an outer shell 1, as shown in the cross-sectional view of FIG. 6. The inner liner 2 and the outer shell 1 may have one or more different characteristics from each other, including, for example, different colors and/or different surface textures. The inner liner 2 and the outer shell 1 may be made from the same material or from different materials. The inner liner 2 and the outer shell 1 are connected together. An internal cavity 3 is defined by and formed internal to the inner liner 2, between the bottom surface of the inner liner 2 and the rim 140. Preferably, the inner liner 2 and outer shell 1 are sealed together. In some embodiments, the inner liner 2 and the outer shell 1 may be shaped such that, when sealed together, a void, or hollow region, is defined between the outer surface of the inner liner 2 and the inner surface of the outer shell 1. This hollow region may thus have a generally annularly-shaped cross-sectional shape or profile (e.g., in the view shown in FIG. 5), extending through at least a portion of the height of the cup 100, preferably a majority of the height of the cup 100 and, still more preferably, from the rim 140 of the cup 100 to and into the base 110 of the cup 100. As used herein, the outer surface of the inner liner 2 is the surface of the inner liner 2 that faces or is closest to, when the inner liner 2 and the outer shell 1 are sealed together, the outer shell 1. Similarly, as used herein, the inner surface of the outer shell 1 is the surface of the outer shell 1 that faces or is closest to, when the inner liner 2 and the outer shell 1 are sealed together, the inner liner 2. Stated somewhat differently, the inner surface of the outer shell 1 and the outer surface of the inner liner 2 face each other when the inner liner 2 and the outer shell 1 are sealed together. In some embodiments, the seal formed between the inner liner 2 and the outer shell 1 can be in the form of a vacuum seal, such that an atmospheric vacuum (e.g., having a barometric pressure lower than the prevailing ambient atmospheric at sea level on Earth) can be provided within the void or hollow region between the inner liner 2 and the outer shell 1. It is particularly advantageous for the seal between the inner liner 2 and the outer shell 1 to be substantially impermeable to liquid, such that liquid cannot be introduced into such void or hollow region after the seal has been formed between the inner liner 2 and the outer shell 1.

The cup 100 has a generally circular profile at the opening 150 of the cup 100 and at the base 110 of the cup 100, with the circumferential wall 120 of the cup having a generally tapered shape between the widest portion of the cup 100, the opening 150, and the narrowest portion of the cup 100, the base 110. The cups and beverage containers disclosed herein, however, is not necessarily limited to such configurations and includes any suitable shape for the opening 150 and the base 110 (e.g., triangular, square, rectangular, polygonal, irregular, sinusoidal, etc.) and for the circumferential wall 120 (e.g., concave, convex, linear, oscillating, irregular, etc.) of the cup 100. In some embodiments, the opening 150 of the cup 100 may be the same diameter or smaller than the diameter of the base 110 of the cup 100. In some embodiments, the opening 150 of the cup 100 may have a different shape than the base 110 of the cup 100. For example, the opening 150 of the cup 100 may be in the form of a circle and the base 110 of the cup 100 may be in the form of a square. In another purely illustrative example, the opening 150 of the cup 100 may be in the shape of a square and the base 110 of the cup 100 may be in the shape of a triangle.

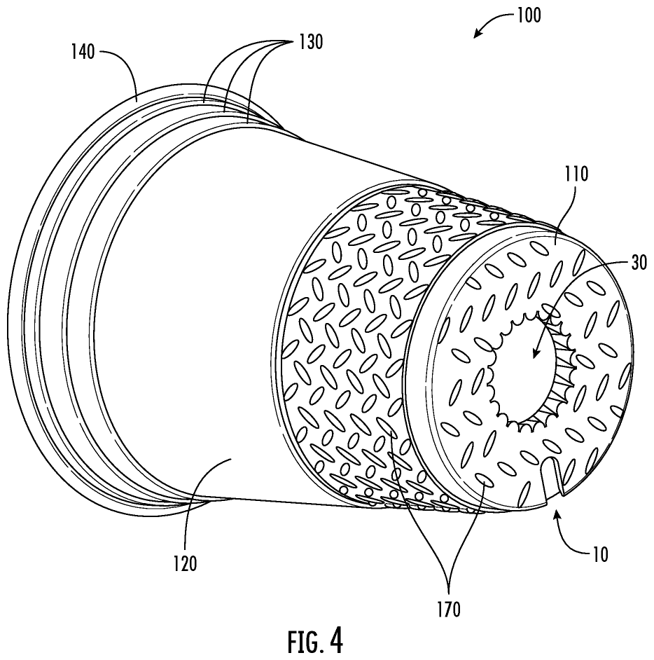

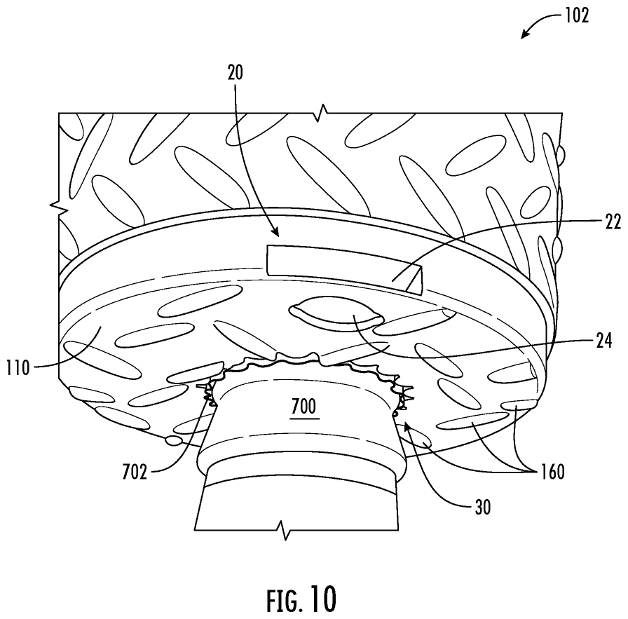

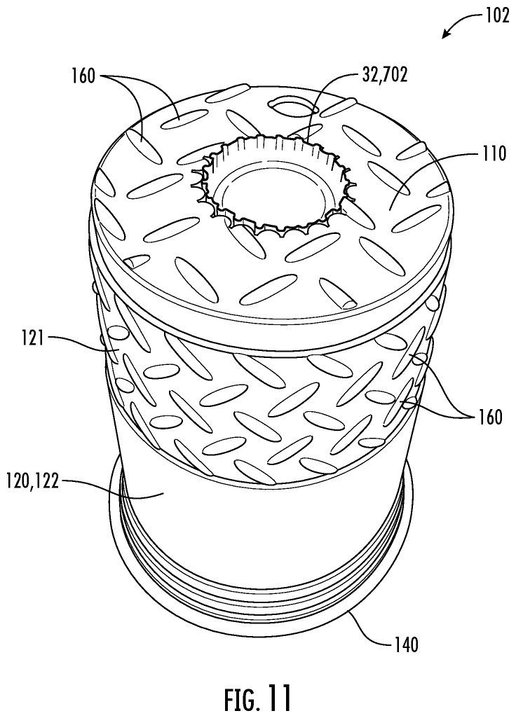

Regardless of the shape of the base 110 of the cup 110, the cup 110 comprises, formed in the base 110 thereof, a bottle opener, generally designated 30. The bottle opener 30 comprises a recess 32, which has an opening that is formed against (e.g., coplanar with and extending in a direction of the rim 140) a bottom surface of the base 110 and extends into the base 110, away from the bottom surface, such that the recess 32 is formed entirely internal to the base 110. In some embodiments, the recess 32 extends to be adjacent to (e.g., directly against) the bottom surface of the inner liner 2. The bottle opener 30 may be formed so as to have a unitary or monolithic construction with the outer shell 1. As best shown in FIGS. 4 and 5, the recess 32 of the bottle opener 34 comprises, spaced around the perimeter of the recess 32 of the bottle opener 30, a plurality of bottle cap ridges 34. As shown in FIG. 6, the ridges 34 can be inclined at an angle with respect to the longitudinal axis of the cup 100. The arrangement of the ridges 34 about the perimeter of the recess 32 is determined by the quantity and spacing of the crimped edges of a conventional bottle cap (e.g., 702, see FIGS. 10 and 11) that are formed when such bottle cap is crimped over the end of a glass bottle (e.g., 700, see FIGS. 10 and 11). Thus, the bottle opener 30 is designed such that a conventional bottle cap can be inserted within the recess 32 and each ridge 34 can engage with one of the crimped portions of a conventional bottle cap such that, upon twisting the bottle relative to the cup 100, the bottle cap can be twisted off of the bottle.

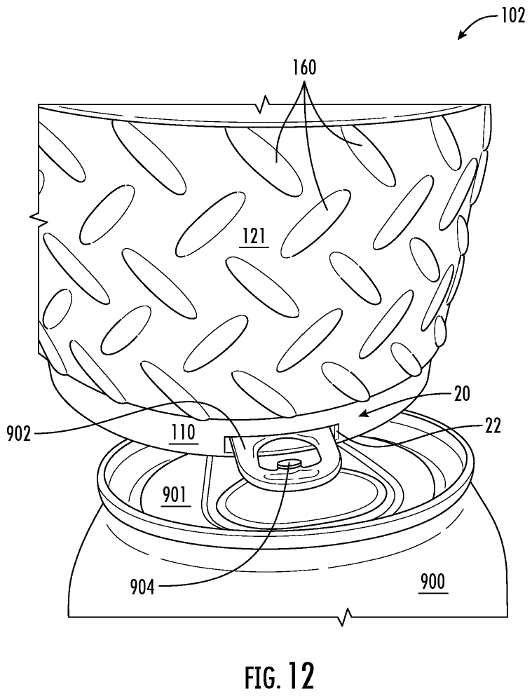

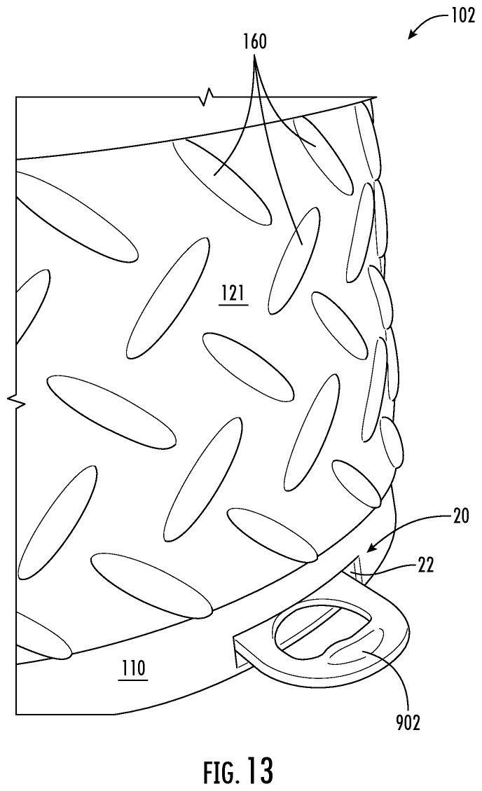

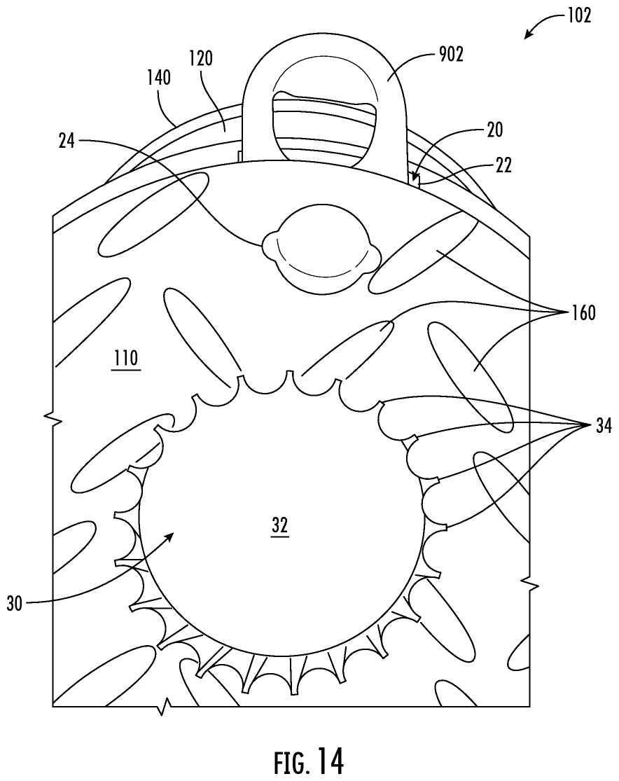

Regardless of the shape of the base 110 of the cup 100, the cup 100 also comprises, formed therein, a can opener 10. The can opener 10 comprises first and second slots 12, 14 that are formed in a radial edge of the base 110 and extend radially inwardly therefrom. Thus, the can opener 10 comprises first and second slots 12, 14 that are formed as a single opening. The first slot 12 is formed spaced apart from the bottom surface of the base 110 by a predetermined thickness. The second slot 14 is formed as an extension of the first slot 12 through this predetermined thickness. The first slot 12 is wider (in the circumferential direction) and deeper (in the radial direction) than the second slot 14 to accommodate a pull tab (e.g., 902, see FIGS. 12-14) of a can (e.g., 900, see FIG. 12) that can be inserted therein for opening the can without a user needing to pull directly on the pull tab with his/her fingers. Thus, during use, the pull tab is inserted into the first slot 12 of the can opener 10. In some embodiments, the second slot 14 can be formed with a sufficient width to accommodate therein the rivet (e.g., 904, see FIG. 12) by which the pull tab is connected to the can lid (e.g., 901, see FIG. 12), meaning that, in such embodiments, the second slot 14 has a width that is at least as large as the rivet that connects the pull tab to the can lid. In some embodiments, the second slot 14 is provided primarily as a drainage slot for egress of water or other fluid from the first slot 12, such as may occur during normal use, cleaning (e.g., flushing the first slot 12 with a cleaning fluid, such as water with or without a surfactant, such as soap, to remove dirt and debris therefrom), and the like. Once the pull tab is inserted a sufficient distance into the first slot 12 to engage the pull tab therein, the can and the cup 100 are pivoted in the direction R, as indicated by the double-ended arrow shown in FIG. 6, to actuate the pull tab and break the seal of the can, thereby opening the can. The pull tab can then be removed from the first slot 12 and the liquid in the can may be dispensed, consumed, etc.

As noted elsewhere herein, the cup 100 can comprise an outer shell 1 and an inner liner 2, which can each be made from the same material or from different materials. In an example embodiment, the inner liner 2 and the outer shell 1 comprise a plastic, melamine, resin, metal, silicone, bamboo, or other composite material that is reusable and dishwasher safe. The inner liner 2 and the outer shell 1 are advantageously formed of materials that are shatterproof (e.g., at temperatures that can safely contact human skin) and durable such that the cup 100 does not bend or collapse when it is gripped during the typical act of drinking from the cup 100 or when using the can opener 10 or the bottle opener 30.

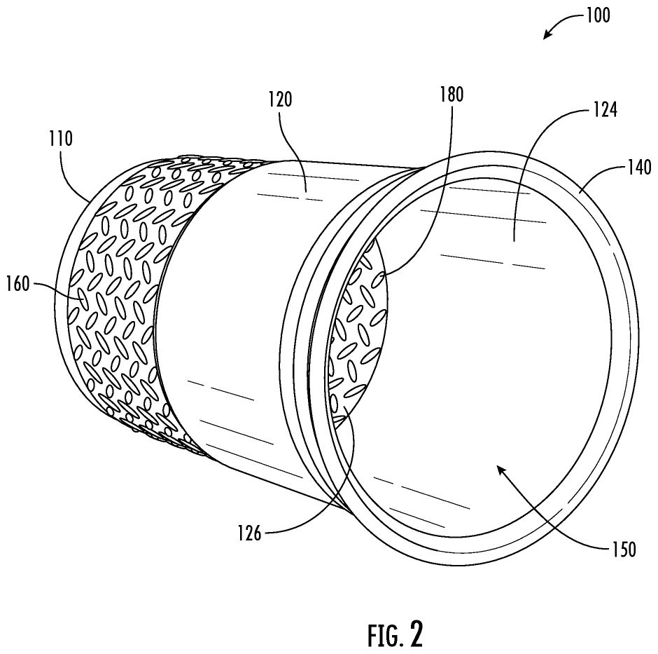

As shown in FIGS. 2, 3, 5, and 6, the cup 100 comprises, embedded within the base 110 thereof, stainless steel or other solid or semi-solid or phase-change material objects, such as “beads” or “discs” (hereinafter, “beads 180”) that are positioned between the inner lining 2 and the outer shell 1 of the cup 100. The beads 180 are, in the example embodiments disclosed herein, positioned between the inner liner 2 and the outer shell 1 of the cup 100. The beads 180 may be provided at any desired height between and including the bottom surface of the inner liner 2 and the rim 140 on/in the inner liner 2 of the cup 100. However, in the example embodiments disclosed herein, the beads 180 are positioned in the layer of the base 110 of the cup 100 that is in a plane parallel to the base 110 of the cup 100, between (e.g., in a “sandwiched” manner) the inner liner 2 and the outer shell 1. The beads 180 do not interfere with the functionality of the bottle opener 30, nor do the beads 180 interfere with the functionality of the can opener 10. The beads 180 can advantageously be used for forming a texture or design on the inside and outside of the cup 100, since the inner liner 2 and the outer shell 1 of the cup 100 can be designed so as to conform to and have a similar external textured appearance and feel to the beads 180. The provision of such textured surface on the outer surface (e.g., on the base 110 and/or on any portion of the wall 120) of the cup 100 by the use of such beads 180 can improve the user's ability to grip the cup 100 and to also prevent the cup 100 from sliding if or when placed on surfaces that may be inclined with respect to the gravitational force vector. Additionally, the textured surface formed on the inner surface of the inner liner 2 advantageously increases the conductive surface area, which inherently improves heat transfer efficiency for heating or cooling a liquid within the cup 100. Furthermore, the beads 180 may be used for insulating the cup 100 to maintain the temperature of a liquid within the cup 100 for a longer period of time than is otherwise possible without the use of such beads 180. The use of such beads 180 is further advantageous because, by adding mass to the base 110 of the cup 100, the center of mass of the cup 100 is lowered, thus making the cup 100 less likely to tip over when placed on a slanted surface, when the cup 100 may be exposed to wind, and the like, such as might be experienced outdoors, on a boat, etc.

In the example embodiment shown in FIGS. 1-6, the cup 100 has a wall 120 that has a substantially annular cross-section and that extends between the base 110 and the rim 140. The wall 120 comprises at least a first portion 121 and a second portion 122, the first portion 121 being a portion intended for a user to use for grasping the cup 100 in his/her hand. This first portion 121 comprises a plurality of protrusions 160 formed on the external surface of the outer shell 1 for the purpose of aiding the user in grasping the cup 100. Thus, the first portion 121 can be referred to in some instances as a “textured portion.” In some embodiments, this first portion 121 can be manufactured from a silicone or other rubber or plastic material to improve the slip resistance characteristics of the cup 100 in the user's hand. In some embodiments, this first portion 121 can be manufactured from a metal, with the protrusions 160 being formed as silicone, rubber, or plastic textured elements that protrude from the metal, in the manner of silicone, rubber, or plastic “feet” (figure). For purposes of this application, the portion of the cup 100 between the first portion 121 and the rim 140 is referred to as the second portion 122. An annularly-shaped ridge 124 can be formed between the first and second portions 121, 122 of the wall 120 of the cup 100. This ridge 124 can be, in some embodiments, coated or otherwise covered with a silicone or plastic or other material to improve grip, soften the feel of the ridge 124 when the cup 100 is being held by a user, and facilitate a better transition from the textured first portion 121 to the non-textured second portion 122 of the wall 120 of the cup 100.

In some embodiments, the first portion 121 of the wall 120 of the cup 100 is formed as a textured section. In some such embodiments, the textured section comprises a plurality of protrusions 160 that are generally the same shape of the beads 180 embedded within the interior of the cup 100. In some embodiments, the textured section resembles a diamond steel pattern, leather grain, dimpled golf-ball pattern, raised disc pattern, or other patterns that are designed to functionally enhance insulation, resist the cup 100 from slipping on a surface, and to improve the grip of the user on the cup 100 and the friction of the base 110 of the cup 100 on a surface.

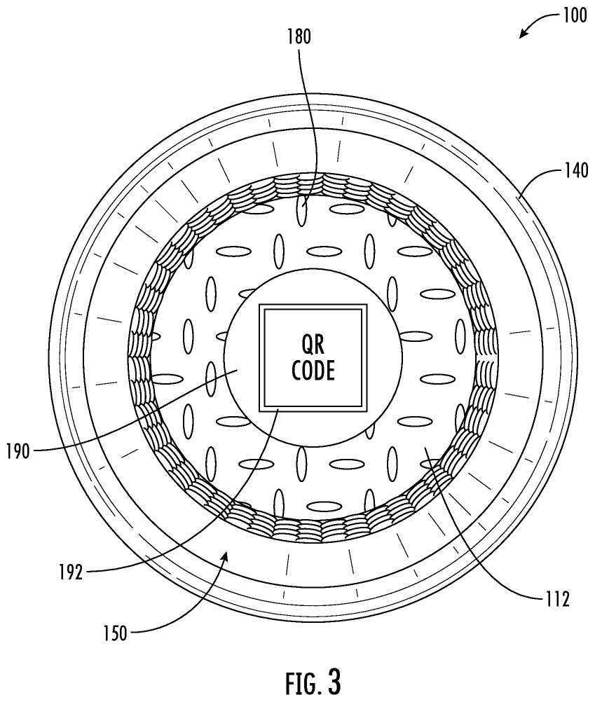

In the example embodiment shown in FIGS. 1-6, the second portion 122 of the wall 120 of the cup 100 has a generally smooth outer surface that is connected to a plurality of stepped surfaces that are connected at circumferential ridges 130. These circumferential ridges 130 are designed to aid in gripping the cup 100 to prevent the cup 100 from slipping out of a user's hand. The smooth surface of the second portion 122 can, in some embodiments, be a surface useful for printing thereon custom logos, names, or designs. The interior view of the cup shown in FIG. 3 shows that, on the base 110 of the cup 100, a region 190 can be provided that is devoid of such protrusions 160 or beads 180 on which a QR code 192 may be provided, such QR code 192 being of the kind that may be scanned to allow the user to interact with users of other cups 100 and/or social media contacts. The QR code 192 is a code that is, in some embodiments, configured to provide information (e.g., a hyperlink or other URL) to a user when scanned by a user's internet-connected device, such as a smartphone. This QR code 192 may be unique to the cup 100 in which the QR code 192 is installed. The use of the QR code 192 is merely an example and any suitable machine-readable code (e.g., a bar code) can be used in the location shown for the QR code 192 within the cup 100.

The inner liner 2 of the cup 100 can have, for example, a thickness in the range of about 0.7 mm to about 1.2 mm, inclusive. The outer shell 1 of the cup 100 can also have, for example, a thickness in the range of about 0.7 mm to about 1.2 mm, inclusive. The bottom surface (e.g., at the base 110) of the cup 100 can have a diameter in the range of about 50 mm to about 100 mm, inclusive, such that the cup 100 can fit into many standard cup holders in vehicles or on a standard coaster. The rim 140 of the cup 100 can have a diameter in the range of about 80 mm to about 120 mm, inclusive, such that the cup 100 may be suitable for general use as a drinking vessel that fits comfortably in the hand of an adult user. The cup 100 may be embodied at any suitable scale, or size. For example, the cup 100 may be sized to contain up to about 6 fluid ounces therein. In another example, the cup 100 may be sized to contain up to about 12 fluid ounces therein. In another example, the cup 100 may be sized to contain up to about 16 fluid ounces therein. In another example, the cup 100 may be sized to contain up to about 18 fluid ounces therein. In another example, the cup 100 may be sized to contain up to about 20 fluid ounces therein. In another example, the cup 100 may be sized to contain up to about 24 fluid ounces therein. In another example, the cup 100 may be sized to contain up to about 32 fluid ounces therein. Thus, the dimensions of the cup 100 may be selected to produce a cup 100 that has an internal volume within a range of about 6-24 fluid ounces or more.

The cup 100 comprises, at a top edge or surface thereof, a rim 140 that is generally annularly shaped and defines the opening 150 of the cup 100. The rim 140 has a generally rounded profile and comprises, in some embodiments, a plurality of small, shallow, circular, concentric grooves. In some embodiments, these grooves can be of the type similar to those formed on a vinyl record. These grooves are provided to improve the ability of the rim 140 to hold salt, sugar, or other garnishes that might typically be used to adorn the rim of drinking vessels holding cocktails or frozen beverages. In some embodiments, the inner liner 2 and/or the outer shell 1 comprise a BPA-free plastic, like ABS, with or without stainless steel beads 180 embedded within the base 110 of the cup 100.

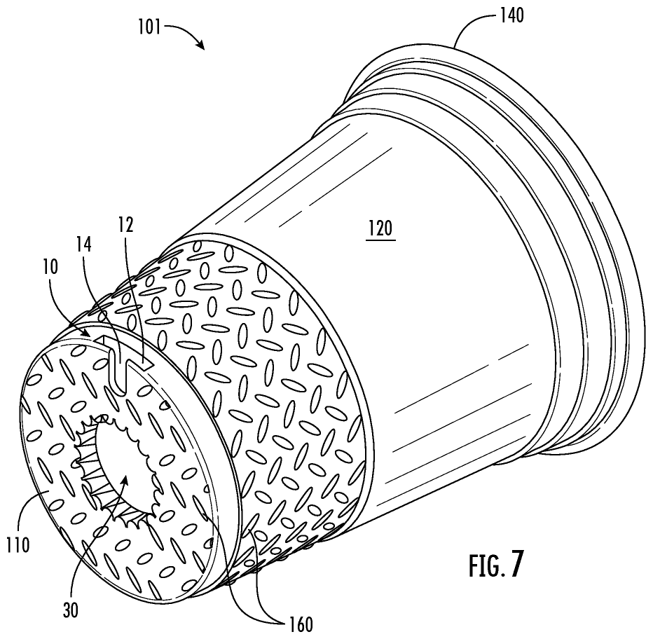

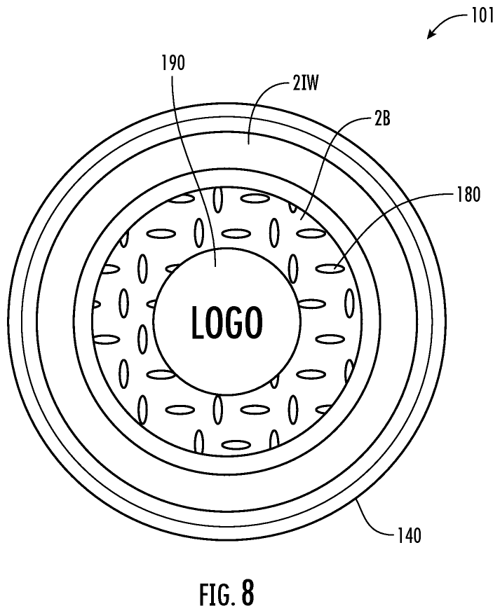

FIGS. 7 and 8 show various aspects of another example embodiment of a beverage container, or cup, generally designated 101. Unlike in the example embodiment of the cup 100 shown in FIGS. 1-6, in FIGS. 7 and 8 the inner wall of the inner liner 2 is substantially smooth between the bottom surface of the inner liner 2 and the rim 140 of the cup. Structures, functions, and features of the cup 101 shown in FIGS. 7 and 8 that are not expressly described herein as being different from the cup 100 are substantially similar to (e.g., identical to) the corresponding structures of the cup shown and described elsewhere herein in relation to FIGS. 1-6.

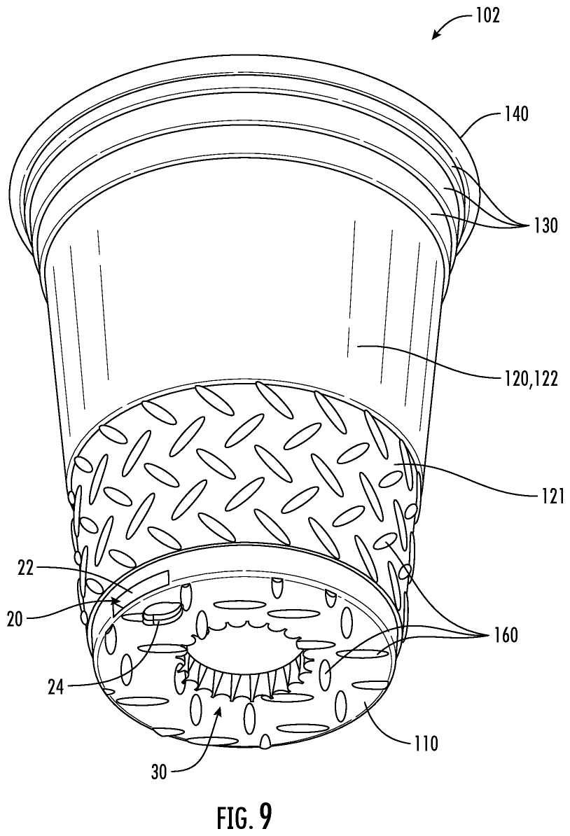

FIGS. 9-14 show various aspects of another example embodiment of a reusable beverage holder, or cup, generally designated 102. Structures, functions, and features of the cup 102 shown in FIGS. 9-14 that are not expressly described herein as being different from the cup 100 are substantially similar to (e.g., identical to) the corresponding structures of the cup 100 shown and described elsewhere herein in relation to FIGS. 1-6. According to this example embodiment, the cup 102 is substantially similar to the features of the other example embodiments disclosed herein, with the exception of the can opener, generally designated 20, provided in the base 110 of the cup 102. In this example embodiment, the can opener 20 comprises a single slot 22 (“pull tab slot”) that extends radially inwardly from the perimeter of the base 110. The can opener 20 further comprises a hole 24 that is spaced apart from the perimeter of the base 110 and is formed through a thickness of the bottom surface of the base 110, such that an outlet of the hole 24 is coincident with the slot 22 of the can opener 20. The hole 24 is formed as a drain hole for allowing any fluid and/or debris present within the slot 22 of the can opener 20 to be drained out of the slot 22 through the hole 24 and through the base 110 of the cup 102 to promote a manner of more easily cleaning the can opener 20 that does not have such a hole 24. The hole 24 is advantageously formed so that a radial portion thereof is formed substantially continuously with the radially inward surface of the slot 22, so that no portion, or only a negligible portion, of the slot 22 extends radially inwards beyond the hole 24.

FIGS. 10 and 11 show the bottle opener, generally designated 30, of the cup 102 being used for engaging with and removing (e.g., by twisting) a bottle cap 702 from a bottle 700 to which the bottle cap 702 is threadably engaged. FIG. 11 in particular shows the manner in which the ridges 34 of the bottle opener 30 that are formed around the perimeter of the recess 32 engage with the crimped ridges of the bottle cap 702 that will be or has been removed from the bottle 700. It is advantageous for the depth of the recess 32 to be such that a portion of the bottle cap 702 extends out of the recess 32 to allow for removal bottle cap 702 from the recess 32 after the bottle cap 702 has been twisted off of the bottle 700. Thus, in a first step, the bottle cap 702 is inserted within the recess 32 such that each crimped ridge of the bottle cap 702 is engaged within a corresponding one of the bottle cap ridges 34 formed about the perimeter of the recess 32 of the bottle opener 30. In a second step, the cup 102 is twisted or rotated relative to the bottle cap 702 about a longitudinal axis of the cup 102 and/or bottle 700 to unscrew the bottle cap 702 from the mouth of the bottle 700. In a third step, the bottle cap 702 is removed from the recess 32 of the bottle opener 30.

FIGS. 12-14 show the can opener 20 of the cup 102 being used for engaging with a pull tab 902 of a can 900 and pivoting such pull tab 902 about the rivet 904 by which the pull tab 902 is connected to the top 901 of the can 900. Thus, in a first step, the pull tab 902 is inserted within the slot 22 of the can opener 20. In a second step, the cup 102 and the can 900 are pivoted with respect to each other about an axis by which the pull tab 902 is pivotable about the rivet 904 to break the seal of the can 900. In a third step, the pull tab 902 is removed from the slot 22 of the can opener 20.

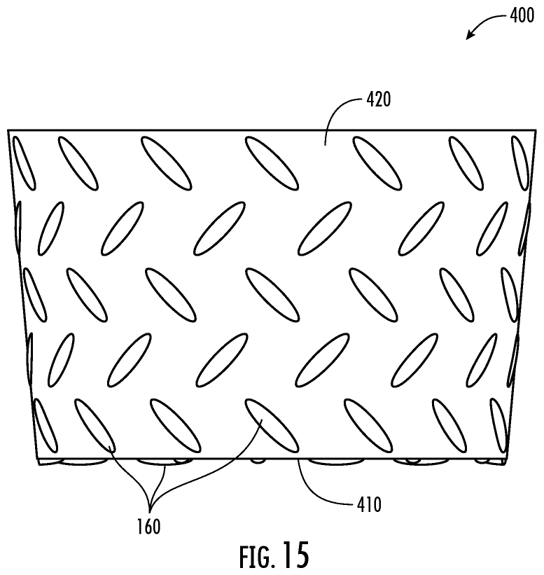

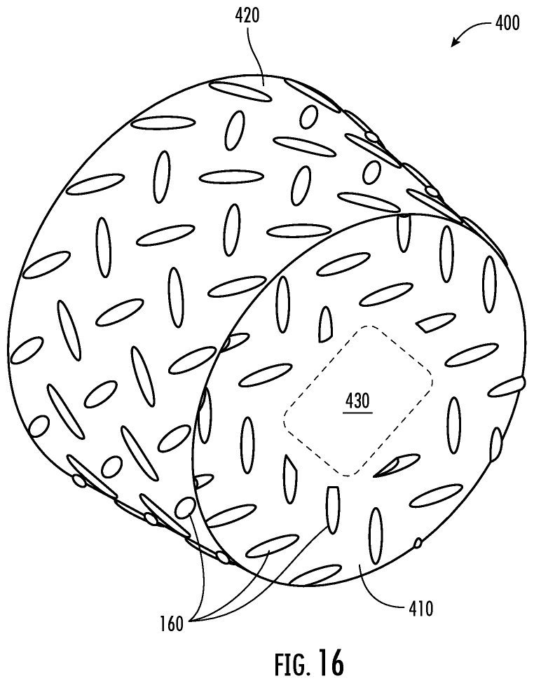

FIGS. 15 and 16 show various aspects of a sleeve, generally designated 400, that can be used in conjunction with any of the cups 100, 101, 102, 103 disclosed herein. The sleeve 400 can also be referred to as a “skin” for the cups 100, 101, 102, 103. The sleeve 400 has, in the example embodiment shown in FIGS. 15 and 16, a generally cylindrically- or frustoconically-shaped side wall 420 and a bottom wall 410, such that one longitudinal end of the sleeve 400 is open and the other longitudinal end of the sleeve 400 is closed (e.g., by the bottom wall 410). The sleeve 400 is advantageously configured for removable installation over the end of a cup (e.g., 100, 101, 102, 103) that comprises the base 110 thereof. The sleeve 400 is form-fitted to cover the base 110 and first portion 121 (e.g., the textured lower portion) of the cup, such that the sleeve 400 engages with the cup to a sufficient degree to ensure that, at least during routine use of the cup for holding beverages therein, the cup and sleeve 400 will remain connected to each other and cannot be separated unless a separation force is applied to separate the sleeve 400 from such cup.

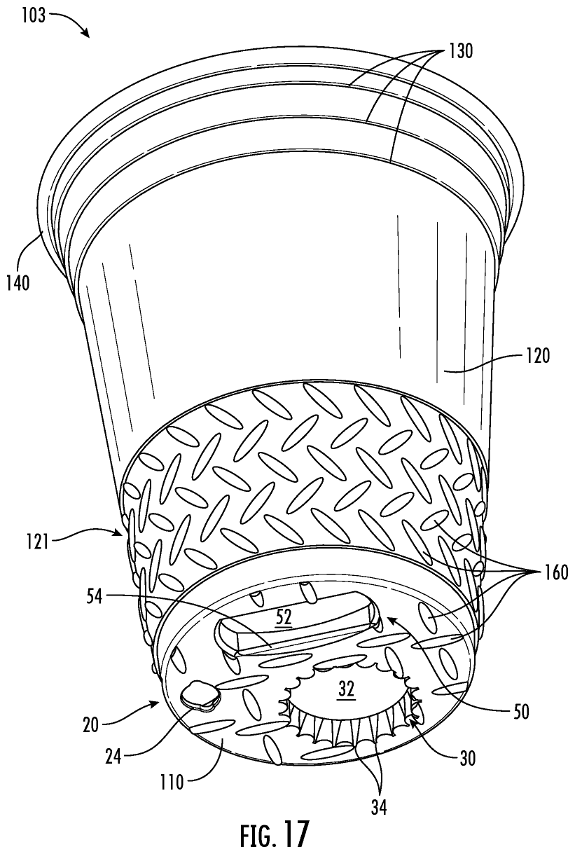

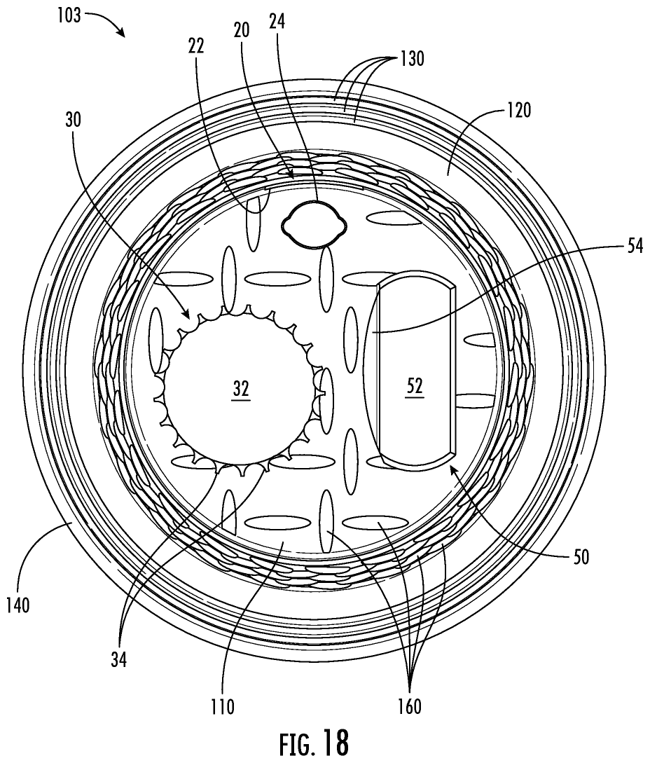

The sleeve 400 can be formed of silicone or rubber, but is not necessarily limited thereto; thus, in some embodiments, the sleeve 400 can be formed of any of a variety of different solid or semi-solid materials. In some embodiments, the sleeve 400 can be made of a metal (e.g., stainless steel) with silicone and/or plastic textured elements (e.g., in the form of a plurality of “feet”) that are compressed when such a sleeve is engaged with the outer surface of a cup to ensure a sufficiently secure fit of the sleeve 400 over the outer surface of the cup to prevent unwanted separation of the sleeve 400 from the cup during normal use. In some embodiments, such textured elements may be provided on the inner and outer surfaces of the sleeve 400, such that the portion of the textured features on the inner surface of the sleeve 400 can engage with the outer surface of a cup for removably attaching the sleeve 400 to the cup and the portion of the textured features (e.g., protrusions 160) on the outer surface of the sleeve 400 can be used to aid in a user's hand being able to grip the sleeve 400 and/or to resist the sleeve 400 from slipping and/or sliding when the sleeve 400 is in contact with a surface. In some embodiments where the sleeve 400 is made of a substantially rigid material, the sleeve 400 may comprise a silicone lining over some or all of the inner surface thereof to ensure a sufficiently secure fit of the sleeve 400 with the cup to prevent unwanted separation of the sleeve 400 from the cup during normal use. In some such embodiments in which the sleeve 400 comprises a sufficiently rigid material, such as a metal material (e.g., stainless steel), the sleeve 400 can further comprise, formed in the side wall 420 and/or the bottom wall 410 thereof, one or more of (e.g., all of) a lever-type bottle opener (e.g., 50, see FIGS. 17 and 18), a twist-off bottle opener (e.g., 30, see FIGS. 1-14, 17, and 18), and a can opener (e.g., 10, see FIG. 1-8, or 20, see FIGS. 9-14, 17, and 18). In some embodiments in which the sleeve 400 is formed out of a metal material, the uppermost rim (e.g., the edge of the side wall 420 that is furthest from the bottom wall 410) is coated with, or otherwise covered with, a material that is softer than the metal from which the sleeve 400 is formed to soften the uppermost edge of the sleeve 400 for increased user comfort and to also aid in the sleeve 400 being better engaged with the cup over which such sleeve 400 is positioned; examples of such material that is softer than the metal from which the sleeve 400 is formed are silicone and plastic.

The sleeve 400 comprises, on the surface thereof, a plurality of protrusions 160 on the side wall 420 and bottom wall 410 of the sleeve 400, such that the outer surface of the sleeve 400 is textured to resist slipping either in a user's hand when holding the cup and sleeve 400 while the cup and sleeve 400 are engaged together. The texture provided by the protrusions 160 also resists the cup from slipping and/or sliding when the sleeve 400 is engaged with the cup and in contact with a surface. The sleeve 400 also provides insulation for the cup to maintain a temperature of a beverage within the cup for a longer period of time than for a cup without such a sleeve 400 installed thereon. The sleeve 400 can be advantageously provided in any of a plurality of colors and/or textures, such that the sleeve 400 on a first cup may be readily determined to be different from the sleeve 400 on a second cup visually and/or by touch; thus, sleeves 400 that have different appearances may be used to easily to distinguish one person's cup system from another person's cup.

Still referring to the example embodiment of the sleeve shown in FIGS. 15 and 16, it is noted that the pattern of the protrusions 160 formed in and/or on the sleeve 400 is envisioned as being substantially identical to and/or reciprocal to those on the first portion 121 of the wall 120 of the cup 100, 101, 102, 103 to which the sleeve 400 is attached. Specifically, the protrusions 160 on the external surface of the sleeve 400 correspond to and form indentations of a substantially similar size on the internal surface of the sleeve 400. Since the indentations formed on the internal surface of the sleeve 400 have a substantially identical spatial positioning to the protrusions 160 formed on the external surface of first portion 121 of the wall 120 of the cup 100, 101, 102, 103, each of these indentations formed on the internal surface of the sleeve 400 is positioned so as to engage or couple with a corresponding one of the protrusions 160 formed in the first portion 121 of the wall 120 of the cup 100, 101, 102, 103. Thus, the cup and sleeve 400 will couple together by engagement of the protrusions 160 on the external surface of the first portion 121 of the wall 120 of the cup 100, 101, 102, 103 within corresponding indentations formed in the internal surface of the sleeve 400. In order to engage such protrusions 160 within the indentations, the sleeve 400 and the cup must be positioned relative to each other in the proper orientation to align the patterned protrusions 160 on the external surface of the first portion 121 of the wall 120 of the cup 100, 101, 102, 103 with the patterned indentations in the internal surface of the sleeve 400.

In order to facilitate proper orientation of the cup and sleeve 400 to engage the protrusions 160 of the cup and the indentations of the sleeve 400 with each other, such as when a user is installing a sleeve over the base 110 and/or first portion 121 of the wall 120 of the cup 100, 101, 102, 103, there may be provided on the cup and/or the sleeve 400 directional, interior markings (e.g., markings on the interior surface of the sleeve) that direct such user how to align the sleeve 400 with the cup such that alignment between the patterned protrusions 160 and the patterned indentations is optimized for engagement with each other. Examples of such alignment markings can be in the form of a raised pattern, like an arrow, written words like “align tab opener here”, or slightly raised outlines of one or more protrusions 160 on the cup and/or the sleeve 400 that help guide one of the pattern elements of the sleeve 400 to fit over the reciprocal or analogous element on the cup surface. The purpose of this coupling mechanism and directional system for the user is to provide a secure fit of the sleeve 400 onto the cup, and to prevent air, fluid, debris, etc. from being trapped between the cup and the sleeve 400.

In some embodiments, the pattern in which the protrusions 160 are formed on the cup 100, 101, 102, 103 and/or sleeve 400, as well as the shape of the protrusions 160 themselves, can be in the form of Braille communication that may be customized for presenting a logo, slogan, phrase, series of numbers, or any desired form of Braille writing. The formation of the protrusions 160 as Braille will enable any user of this system that is fluent in Braille to understand the written communication presented in Braille by the protrusions 160 on the cup 100, 101, 102, 103 and/or sleeve 400 even if such user is visually impaired.

In another example embodiment, the pattern in which the protrusions 160 are formed on the cup 100, 101, 102, 103 and/or sleeve 400 may form a series of numeric characters in the form of binary code (i.e., machine language using only a string of zeros and ones) that may be customized for presenting to a user fluent in binary code a word, word mark, slogan, phrase, initials, or any desired communication via such binary code formed by the protrusions 160. Thus, by forming the protrusions on the cup 100, 101, 102, 103 and/or sleeve 400 to form a sequence of characters in binary code, any person who sees the binary code formed on the cup 100, 101, 102, 103 and/or the sleeve 400 and who is sufficiently fluent in binary code to receive and comprehend the written communication formed by the binary code.

The cup 100, 101, 102, 103 disclosed in the example embodiments shown and described herein can be used for allowing a user to drink chilled or warmed beverages from such a cup 100, 101, 102, 103.

FIGS. 17 and 18 show various aspects of another example embodiment of a reusable beverage container, or cup, generally designated 103. The cup 103 is suited for the containment, transport, and consumption of liquid therein and/or therefrom. Structures, functions, and features of the cup 103 shown in FIGS. 17 and 18 that are not expressly described herein as being different from the cup 100 are substantially similar to (e.g., identical to) the corresponding structures of the cup 100 shown and described elsewhere herein in relation to FIGS. 1-6. In the example embodiment shown, the cup 103 comprises, formed in the base 110 of the cup 103 (e.g., integrally, such as in a single piece, or so as to have a monolithic construction), a lever-style bottle opener, generally designated 50, that can be used to remove bottle caps (e.g., 702, see FIGS. 10 and 11) from a bottle (e.g., 700, see FIG. 10), such bottle caps 702 being sealed over the mouth of a bottle 700 in such a manner as to not be removable from the bottle 700 by a twisting motion or action.

In this embodiment, the lever-style bottle opener 50 comprises a recess 52 formed in the base 110 of the cup 103, which extends inwardly (e.g., in the direction of the longitudinal axis of the cup 103) from the bottom surface of the base 110. The lever-style bottle opener 50 also comprises, extending over a portion of the recess 52 and substantially coplanar with the bottom surface of the base 110, a lever arm 54. The lever arm 54 is thus formed such that at least a portion of the recess 52 of the lever-style bottle opener 50 is bounded by the lever arm 54 and does not open directly to the external environment through the base 110 of the cup 103. This lever arm 54 and the internal portion of the recess 52 of the lever-style bottle opener 50 thus form a shelf- or step-like structure into which the peripheral edge of a bottle cap 702 secured onto a bottle 700 can be inserted. For separating the bottle cap 702 from the bottle 702, a lower edge of the bottle cap 702 is engaged against the inner edge of the lever arm 54 and the bottle 700 is pivoted (e.g., about the axis defined by the generally longitudinally-extending edge of the lever arm 54) with respect to the cup 103 to apply a removing force to the bottle cap 702 that will pry the bottle cap 702 off of the mouth of the bottle 700, thereby separating the bottle cap 702 from the bottle 700 with no twisting motion (e.g., a rotating motion about the longitudinal axis of the cup 103) occurring between the bottle cap 702 and the cup 103. The lever-style bottle opener 50 can also be used, in the same manner as described immediately hereinabove, to remove a threadably engaged (e.g., “screw-off”) bottle cap 702 from a bottle 700.

In order to allow for repeated use of the lever-style bottle opener 50, the portion of the base 110 of the cup 103 around the lever-style bottle opener 50 (e.g., at least the lever arm 54) must be made of a sufficiently hard and durable material, preferably a metal or carbon fiber, which will not be damaged by the prying action of the crimped ridges of the bottle cap 702 against the lever arm 54 of the lever-style bottle opener 50. It is particularly advantageous for the lever arm 54 to be comprised of, at least partially (e.g., at least on the portion of the lever arm 54 that directly contacts the bottle cap 702 during the bottle opening process) or entirely, a material that has a hardness that is greater than the hardness of the material from which the bottle caps 702, which are anticipated to be removed using the lever-style bottle opener 50 of the cup 103, are made. In some embodiments, the lever arm 54 consists of a material that has a hardness that is greater than the hardness of the material from which the bottle caps 702, which are anticipated to be removed using the lever-style bottle opener 50 of the cup 103, are made. While the lever arm 54 of the lever-style bottle opener 50 is shown in the example embodiment of the cup 103 illustrated in FIGS. 17 and 18 as being on the radially inner edge of the recess 52 of the lever-style bottle opener 50, the positioning of the lever arm 54 is not limited to the orientation on the recess 54 shown in the example embodiment of the cup 103. To the contrary, the lever arm 54 can be provided on any suitable portion of the recess 52 of the lever-style bottle opener 50, including on a radially outer edge (e.g., with respect to the outer edge of the base 110 of the cup 103) of such recess 52.

As shown in FIGS. 17 and 18, the cup 103 comprises, formed in the base 110 thereof, a lever-style bottle opener 50, a twist-style bottle opener, generally designated 30, and a can opener, generally designated 20. The twist-style bottle opener 30 and the can opener 20 operate substantially similarly to, and are formed substantially similarly to, the bottle openers 30 and can openers 20 described elsewhere herein with respect to other example embodiments of the cup, with the sole exception being that, in order to provide sufficient space for the lever-style bottle opener 50 in the base 110 of the cup 103, the recess 32 of the twist-style bottle opener 30 is not centered on the longitudinal axis of the cup 103 but is instead radially offset from the longitudinal axis of the cup 103. In some embodiments, the recess 52 of the lever-style bottle opener 50 can be positioned to occupy (e.g., be formed in) the peripheral edge of the base 110, such that a portion of the peripheral wall of the base 110 would appear to be missing where the recess 52 of the lever-style bottle opener 50 is coincident therewith in a cup having a lever-style bottle opener 50 with such a construction. In such an embodiment, the perimeter wall of the base 110 of the cup would appear to have a piece missing therefrom. A cup having a lever-style bottle opener formed in the perimeter of the base 110 would allow for the recess 32 of the twist-style bottle opener 30 to be coaxially aligned with the longitudinal axis of such cup.

It is advantageous in all embodiments of the cup 100, 101, 102, 103 for the inner liner 2 and the outer shell 1 to be sufficiently rigid that, when attached to each other, the cup 100, 101, 102, 103 will not deform when filled with a liquid and held in the hand of a user.

It is understood that the example embodiments disclosed herein are not limiting and do not restrict the object disclosed herein. In particular, it will be evident to the person skilled in the art that the features described herein may be combined with each other arbitrarily, and/or various features may be omitted therefrom, without any resultant devices, systems, and/or methods deviating from the subject matter disclosed herein.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise.

1. A reusable beverage container comprising:
an inner liner comprising a cavity that is configured to contain a fluid therein;
an outer shell attached over an external surface of the inner liner; and
one or more of:
a bottle opener; and
a can opener.

2. The beverage container of claim 1, wherein:
the outer shell comprises a base, which has a bottom surface that defines a bottom of the beverage container; and
the bottle opener is in a form of a recess that is formed in and extends away from the bottom surface of the outer shell, in a manner such that the recess is internal to the base of the outer shell, the recess being configured for engaging with a bottle cap for removing the bottle cap from a bottle.

3. The beverage container of claim 2, wherein:
the bottle cap comprises a plurality of vertically oriented ridges formed around an outer circumferential surface thereof;
the recess is formed such that a plurality of vertically oriented ridges are formed around an inner circumferential surface thereof;
the ridges are formed and spaced about the inner circumferential surface of the recess such that a corresponding one of the ridges of the bottle cap can be inserted therein; and
when the beverage container and the bottle are twisted relative to each other along a longitudinal axis of the beverage container, the bottle opener is configured to twist the bottle cap off of the bottle; and/or
wherein the can opener comprises a slot that is formed in an outer circumferential surface of the base, the slot extending radially inwardly from the outer circumferential surface.

4. The beverage container of claim 3, wherein:
the slot is configured such that a pull tab of a can is insertable at least partially into the slot such that, by moving the can relative to the beverage container about a pivot point of the pull tab, the beverage container is configured to actuate the pull tab for opening the can; and/or
the can opener comprises a hole or second slot configured for draining from the slot a fluid and/or debris contained within the slot during a cleaning process of the beverage container.

5. The beverage container of claim 1, comprising a plurality of beads within a base of the beverage container to resist the beverage container from tipping over.

6. The beverage container of claim 5, wherein:
the plurality of beads are:
embedded within the inner liner; or
contained within the base between the liner shell and the outer shell;
the plurality of beads comprise a metal and/or a phase-change material and are positioned directly adjacent to the cavity of the inner liner and are configured to provide heat transfer with the fluid for heating or cooling the fluid to maintain a desired temperature of the fluid for a longer period of time than without the plurality of metallic beads;
the plurality of beads form a textured surface within at least a portion of the cavity formed by the inner liner, the texture being configured to improve, relative to a flat surface, an efficiency of heat transfer between the plurality of beads and the fluid; and/or
the plurality of beads are also adjacent to and vertically along a portion of an inner circumferential wall of the inner liner.

7. The beverage container of claim 1, comprising a hollow region formed between the inner liner and the outer shell, wherein the hollow region insulates the fluid.

8. The beverage container of claim 7, wherein the hollow region is vacuum sealed to be devoid of air, liquid, and/or solid within the hollow region.

9. The beverage container of claim 1, wherein the outer shell comprises, formed over a portion of an outer circumferential surface thereof, a plurality of protrusions for aiding manual gripping of the beverage container by a person.

10. The beverage container of claim 9, comprising a plurality of annular ridges about the outer circumferential surface of the outer shell for aiding a person in gripping the beverage container.

11. The beverage container of claim 9, wherein the portion of the outer circumferential surface of the outer shell, over which the plurality of protrusions are formed, is formed of a different material than a remaining portion of the outer circumferential surface of the outer shell.

12. The beverage container of claim 11, wherein the different material comprises silicone, rubber, plastic, and/or metal.

13. The beverage container of claim 1, comprising, at a top surface of the beverage container, an annular rim that defines an opening of the beverage container, the opening being formed such that fluid can be introduced into and extracted from the cavity through the opening.

14. The beverage container of claim 13, wherein:
the rim is a widest portion of the beverage container; and/or
the rim comprises, formed therein, grooves that are configured to retain therein and/or thereon a garnish that is designated to accompany the fluid within the cavity of the inner liner of the beverage container.

15. The beverage container of claim 14, wherein the grooves are concentrically arranged about the rim with respect to each other.

16. The beverage container of claim 1, wherein:
the beverage container comprises a textured surface on a bottom surface of the outer shell, the textured surface being configured to provide insulation to the beverage container and to resist the beverage container from slipping when placed on a surface or when held in a hand of a person; and/or
the cavity of the inner liner is configured to contain therein a maximum volume of the fluid of between about 6 fluid ounces and about 24 fluid ounces, inclusive; and/or
the beverage container is in a form of a cup.

17. The beverage container of claim 1, comprising, formed in the base, a lever-style bottle opener configured to pry a bottle cap off a bottle by engagement of the bottle cap within a recess of the lever-style bottle opener and against a lever arm of the lever-style bottle opener to exert a removal force on the bottle cap.

18. The beverage container of claim 17, wherein the removal force is a moment exerted about an edge of the lever arm.

19. A method of making a multi-function reusable beverage container, the method comprising:
forming an inner liner comprising a cavity for containing a fluid therein;
attaching an outer shell over an external surface of the inner liner; and
forming one or more of:
a bottle opener; and
a can opener.

20. The method of claim 19, wherein:
the outer shell comprises a base, which has a bottom surface that defines a bottom of the beverage container; and
the bottle opener is in a form of a recess that is formed in and extends away from the bottom surface of the outer shell, in a manner such that the recess is internal to the base of the outer shell;
the method comprising:
engaging a bottle cap attached to a bottle in the recess; and
twisting the bottle relative to the beverage container to remove the bottle cap from the bottle.

21. The method of claim 20, wherein:
the bottle cap comprises a plurality of vertically oriented ridges formed around an outer circumferential surface thereof;
the recess is formed such that a plurality of vertically oriented cavities are formed around an inner circumferential surface thereof;
the cavities are formed and spaced about the inner circumferential surface of the recess such that a corresponding one of the ridges of the bottle cap can be inserted therein; and
when the beverage container and the bottle are twisted relative to each other along a longitudinal axis of the beverage container, the bottle opener twists the bottle cap off of the bottle; and/or
wherein the can opener comprises a slot that is formed in an outer circumferential surface of the base, the slot extending radially inwardly from the outer circumferential surface.

22. The method of claim 21, wherein:
the method comprises inserting a pull tab of a can at least partially into the slot such that, by moving the can relative to the beverage container about a pivot point of the pull tab, the beverage container actuates the pull tab for opening the can; and/or
the can opener comprises a hole or second slot for draining from the slot a fluid and/or debris contained within the slot during a cleaning process of the beverage container.

23. The method of claim 23, comprising providing a plurality of beads within a base of the beverage container to resist the beverage container from tipping over.

24. The method of claim 23, wherein:
the plurality of beads are:
embedded within the inner liner; or
contained within the base between the liner shell and the outer shell;
the plurality of beads comprise a metal and/or a phase-change material and are positioned directly adjacent to the cavity of the inner liner and are configured to provide heat transfer with the fluid for heating or cooling the fluid to maintain a desired temperature of the fluid for a longer period of time than without the plurality of metallic beads;
the plurality of beads form a textured surface within at least a portion of the cavity formed by the inner liner, the texture being configured to improve, relative to a flat surface, an efficiency of heat transfer between the plurality of beads and the fluid; and/or
the plurality of beads are also adjacent to and vertically along a portion of an inner circumferential wall of the inner liner.

25. The method of claim 19, comprising forming a hollow region between the inner liner and the outer shell that insulates the fluid.

26. The method of claim 25, wherein the hollow region is vacuum sealed so as to be devoid of air, liquid, and/or solid within the hollow region.

27. The method of claim 19, comprising forming, over a portion of an outer circumferential surface of the outer shell, a plurality of protrusions for aiding manual gripping of the beverage container by a person.

28. The method of claim 27, wherein the portion of the outer circumferential surface of the outer shell, over which the plurality of protrusions are formed, is formed of a different material than a remaining portion of the outer circumferential surface of the outer shell.

29. The method of claim 28, wherein the different material comprises silicone, rubber, plastic, and/or metal.

30. The method of claim 19, comprising forming, at a top surface of the beverage container, an annular rim that defines an opening of the beverage container, the opening being formed such that fluid can be introduced into and extracted from the cavity through the opening.

31. The method of claim 30, wherein the rim is a widest portion of the beverage container; and/or wherein the method comprises forming, in the rim, grooves configured to retain therein and/or thereon a garnish that is designated to accompany the fluid within the cavity of the inner liner of the beverage container.

32. The method of claim 31, wherein the grooves are concentrically arranged about the rim with respect to each other.

33. The method of claim 32, comprising a plurality of annular ridges about the outer circumferential surface of the outer shell for aiding a person in gripping the beverage container.

34. The method of claim 19, wherein:
the method comprises using a textured surface on a bottom surface of the outer shell to insulate the beverage container and to resist the beverage container from slipping when placed on a surface or when held in a hand of a person; and/or
the cavity of the inner liner is shaped to contain therein a maximum volume of the fluid of between about 6 fluid ounces and about 24 fluid ounces, inclusive; and/or
the beverage container is in a form of a cup.

35. The method of claim 19, comprising:
forming a lever-style bottle opener in the base, the lever-style bottle opener comprising a recess and a lever arm;
engaging a bottle cap that is secured over a mouth of a bottle within the recess of the lever-style bottle opener; and
prying the bottle cap off of the bottle by engaging the bottle cap against the lever arm of the lever-style bottle opener to exert a removal force on the bottle cap.

36. The method of claim 35, wherein the removal force is a moment exerted about an edge of the lever arm.
